(19) United States
(12) Patent Application Publication
(10) Pub. No.: US 2026/0235276 A1
(43) Pub. Date: Aug. 13, 2026

(54) LIGHT TRANSMISSION DIRECTION CONTROL SHEET AND METHOD FOR MANUFACTURING SAME

(71) Applicant: Shin-Etsu Polymer Co., Ltd., Tokyo (JP)

(72) Inventors: Susumu Iwama, Nagano (JP); Tsuyoshi Imai, Nagano (JP); Naoya Takizawa, Nagano (JP)

(73) Assignee: Shin-Etsu Polymer Co., Ltd., Tokyo (JP)

(21) Appl. No.: 19/153,870

(22) PCT Filed: Nov. 10, 2023
(86) PCT No.: PCT/JP2023/040593

§ 371 Date: Aug. 5, 2025

(30) Foreign Application Priority Data
Feb. 9, 2023 (JP) 2023-018379

(51) Int. Cl. F21V 11/06; F21V 5/02; F21V 14/00; G02B 1/04; G02B 5/02

(52) U.S. Cl. CPC F21V 11/06; F21V 5/02; F21V 14/006; G02B 1/04; G02B 5/0268

(57) ABSTRACT

A light transmission direction control sheet and its manufacturing method capable of improving transmittance and thinning the sheet are provided. The sheet includes first and second louver layers, an interlayer adhesive layer for these, an obverse surface film layer for the first louver layer, an obverse surface-side adhesive layer for the first louver layer and obverse surface film layer, a reverse surface film layer for the second louver layer, and a reverse-surface side adhesive layer for the second louver layer and reverse surface film layer. The first and second louver layers are laminated crosswise, the first and second louver layers are formed with light-transmitting strips and light-shielding strips arranged alternately, the light-transmitting strips are formed of a light-transmissive silicone rubber, and the light-shielding strips are formed of a colored silicone rubber, the interlayer adhesive layer, obverse surface-side adhesive layer, and reverse-surface side adhesive layer are formed of adhesive silicone rubber.

### TECHNICAL FIELD

The present invention relates to a light transmission direction control sheet and a method for manufacturing the same, the light transmission direction control sheet are used in various detection devices, image display devices for automobiles, and the like to control the light path and the visible angle.

### BACKGROUND TECHNOLOGY

As shown in FIGS. 9 and 10, a conventional light transmission direction control sheet 30 is a thick control sheet that includes first and second louver layer groups 31 and 31A that are arranged vertically opposing each other and laminated and bonded orthogonally via an adhesive layer 33. This conventional light transmission direction control sheet is used in sensors, fingerprint authentication devices and other devices (see Patent Documents 1, 2, 3, and 4).

The first louver layer group 31 has a laminated structure including a first louver layer 32 having excellent rigidity, adhesive layers 33 applied to both the obverse and reverse sides of the first louver layer 32, a light-transmissive obverse surface film layer 34 bonded to the obverse side of the first louver layer 32 via the adhesive layer 33, and a first internal film layer 35 bonded to the reverse side of the first louver layer 32 via the adhesive layer 33.

The first louver layer 32 is formed by alternately arranging light-transmissive sections made of acrylic resin, polycarbonate resin or the like, and minute louver-like elements that block light. The first internal film layer 35 is made of a transparent polyethylene terephthalate resin film with, for example, about 0.2 mm in thickness and excellent strength, and functions to correct the warping of the first louver layer 32, considering a tendency of large warping of the first louver layer 32.

On the other hand, the second louver layer group 31A has a laminated structure including a second louver layer 32A with excellent rigidity, adhesive layers 33 applied to both the obverse and reverse sides of the second louver layer 32A, a second internal film layer 35A bonded to the obverse side of the second louver layer 32A via the adhesive layer 33, and a light-transmissive reverse surface film layer 36 bonded to the reverse side of the second louver layer 32A via the adhesive layer 33. The second internal film layer 35A is bonded to the first internal film layer 35 of the first louver layer group 31 via another adhesive layer 33.

The second louver layer 32A is also formed by alternately arranging light-transmissive sections made of acrylic resin, polycarbonate resin or the like, and minute louver-like elements that block light. The internal film layer 35A is made of a transparent polyethylene terephthalate resin film or the like with approximately 0.2 mm in thickness and excellent strength, and functions to correct the warping of the second louver layer 32A, considering a tendency of large warping of the second louver layer 32A.

### PRIOR ART DOCUMENTS

### Patent Documents

Patent Document 1:

Japanese Patent Application Disclosure No. 2004-109615

Patent Document 2:

Japanese Patent Application Disclosure No. 2016-224259

Patent Document 3:

Japanese Patent Application Disclosure No. 2007-212507

Patent Document 4:

Japanese Patent Application Disclosure No. 2021-99437

### SUMMARY OF THE INVENTION

### Problem To Be Solved By The Invention

The conventional light transmission direction control sheet 30 is configured in a multi-layer structure as described above, and the characteristics of the first and second louver layers 32 and 32A being prone to warping, increases the number of parts, hence producing many interfaces, so there is a risk of reduced transmittance due to reflection at interfaces. Furthermore, because the first and second louver layer groups 31 and 31A need respective internal film layers 35 and 35A, though the warping of the first and second louver layers 32 and 32A can be corrected, it is not possible to create a thin structure, which may cause problems when assembling the sheet into a device.

The present invention has been devised in view of the above, it is therefore an object of the invention to provide a light transmission direction control sheet and a manufacturing method thereof that can realize an improved transmittance and a thin structure.

### Means to Solve the Problem

In order to solve the above problems, the aspect of the invention resides in a sheet comprising:
first and second louver layers opposing to each other;
an interlayer adhesive layer bonding the first and second louver layers;
a obverse surface film layer opposing to a obverse surface of the first louver layer, the obverse surface film layer being light-trans missive;
an obverse surface-side adhesive layer bonding the first louver layer and the obverse surface film layer;
a reverse surface film layer opposing to a reverse surface of the second louver layer, the reverse surface film layer being light-transmissive; and
a reverse-surface side adhesive layer bonding the second louver layer and the reverse surface film layer, wherein
the first and second louver layers are laminated crosswise,
the first and second louver layers are each formed by arranging a plurality of light-transmitting strips and a plurality of light-shielding strips, alternately, each light-transmitting strip is formed of a light transmissive silicone rubber, each light-shielding strip is formed of a colored silicone rubber, and a Shore A hardness of the silicone rubbers is 73 or more and 83 or less when measured with a type A durometer in accordance with JIS K 6253, and
the interlayer adhesive layer, the obverse surface-side adhesive layer, and the reverse-surface side adhesive layer are each formed of adhesive silicone rubber, having a Shore A hardness of 10 or more and 60 or less when measured with a type A durometer in accordance with JIS K 6253, and at least a thickness of the interlayer adhesive layer is 10 um or more and 32 μm or less.

Here, the sheet may be attached to a light source of a detection device that radiates light onto an irradiated object so as to control the optical path of the light.

The sheet may be fitted to an image display device of an automobile so as to control an optical path of light.

Further, it is preferable that a difference in refractive index of the interlayer adhesive layer from the first and second louver layers is 0.02 or lower when measured with a refractometer in accordance with JIS K 7142.

It is also preferable that the silicone rubbers of the first and second louver layers have a tensile strength of 7.5 MPa or more and 13.5 MPa or less when measured in accordance with JIS K 6251, an elongation at break of 270 % or more and 490 % or less when measured in accordance with JIS K 6251, and a tear strength of 8 kN/m or more and 28 KN/m or less when measured in accordance with JIS K 6252.

In order to solve the above problems, the aspect of the invention also resides in a method for manufacturing the light transmission direction control sheet according to one or more embodiments, comprising the steps of:
stacking a plurality of silicone rubber sheets for light transmitting strips and a plurality of silicone rubber sheets for light-shielding strips alternately to form a laminate;
pressurizing the laminate and cutting the laminate to form first and second louver layers;
applying adhesive silicone rubber to each of opposing surfaces of the first and second louver layers, an exposed surface of the first louver layer, and an exposed reverse surface of the second louver layer;
laminating and bonding the first and second louver layers crosswise to each other;
laminating and bonding an obverse surface film layer to the obverse surface of the first louver layer; and
laminating and boding a reverse surface film layer to the reverse surface of the second louver layer.

The physical property values of the silicone rubbers of the first and second louver layers in one or more embodiments may include approximate values as long as the same advantages can be obtained. The irradiated object may include at least transparent, opaque, and translucent solids, liquids, and droplets. Examples of the irradiated object may include various mechanical parts, electrical and electronic parts, transparent bottles and containers, medicinal liquids and droplets, etc. The detection device may include a device that detects at least the presence, position, size, shape, number, flow rate, speed, and others of the irradiated object. Furthermore, the light transmission direction control sheet according to the present invention can be used at least in detection devices, image display devices, medical equipment such as infusion devices, liquid crystal displays, CIDs, water meters, and others.

According to the present invention, the first and second louver layers are formed of silicone rubber that is flexible and free from warping, so the number of multiple internal film layers and adhesive layers having different refractive indices can be reduced. In addition, reduction of the number of parts makes it possible to thin the entire light transmission direction control sheet.

### ADVANTAGES OF THE INVENTION

According to the present invention, formation of the light transmitting strips of the first and second louver layers from light-transmissive silicone rubber and formation of the light-shielding strips from colored silicone rubber make it possible to achieve improved transmittance and thinning. Furthermore, since the Shore A hardness of the silicone rubber is 73 or more and 83 or less when measured with a type A durometer in accordance with JIS K 6253, warping or deformation of the first and second louver layers can be prevented.

According to one or more embodiments of the invention, since the light transmission direction control sheet according to the present invention is attached to the light source of the detection device, the edge of the irradiated object can be clarified so as to detect the shape and dimensions of the irradiated object when the irradiated object is opaque. Also, when the irradiated object is transparent or translucent, the edge of the irradiated object can be made visible clearly so as to detect the presence or absence and the position of the irradiated object.

According to one or more embodiments of the invention, since the light transmission direction control sheet according to the present invention is fitted to the image display device of the automobile, it is possible to eliminate the risk of the image of the image display device being reflected on the windshield or door glass of the automobile by controlling the emission of light from the image display device, thereby causing interference with the driving of the automobile.

According to one or more embodiments of the invention, since the difference in refractive index of the interlayer adhesive layer from the first and second louver layers is 0.02 or lower when measured with the refractometer in accordance with JIS K 7142, this specification can contribute to preventing reflection at interfaces in the light transmission direction control sheet.

According to one or more embodiments of the invention, it is expected to prevent warping and deformation of the light transmission direction control sheet by numerically limiting the tensile strength, elongation at break, and tear strength of the silicone rubbers of the first and second louver layers.

According to one or more embodiments of the invention, a laminate is formed by alternately stacking a plurality of silicone rubber sheets for light-transmitting strips and a plurality of silicone rubber sheets for light-shielding strips, and the laminate is pressurized and then cut to form the first and second louver layers, so that it is possible to quickly and easily manufacture the first and second louver layers having multiple light transmitting strips and light-shielding strips arranged alternately.

### BRIEF DESCRIPTION OF DRAWINGS

FIG. 1 A front illustrative diagram schematically showing an embodiment of a light transmission direction control sheet according to the present invention.

FIG. 2 A side illustrative diagram schematically showing the embodiment of the light transmission direction control sheet according to the present invention.

FIG. 3 An exploded illustrative diagram schematically showing the embodiment of the light transmission direction control sheet according to the present invention.

FIG. 4 A plan illustrative diagram schematically showing a second embodiment of the light transmission direction control sheet according to the present invention, where the light transmission direction control sheet is attached to a detection device.

FIG. 5A plan illustrative diagram schematically showing a problem in the second embodiment of the light transmission direction control sheet according to the present invention.

FIG. 6 A plan illustrative diagram schematically showing a third embodiment of the light transmission direction control sheet according to the present invention, where the light transmission direction control sheet is attached to a detection device.

FIG. 7 A plan illustrative diagram schematically showing a problem in the third embodiment of a light transmission direction control sheet according to the present invention.

FIG. 8 A front illustrative diagram schematically showing a fourth embodiment of a light transmission direction control sheet according to the present invention.

FIG. 9 A front illustrative diagram showing a conventional light transmission direction control sheet.

FIG. 10 A front illustrative diagram showing first and second louver layer groups before being bonded in the conventional light transmission direction control sheet.

### EMBODIMENTS FOR CARRYING OUT THE INVENTION

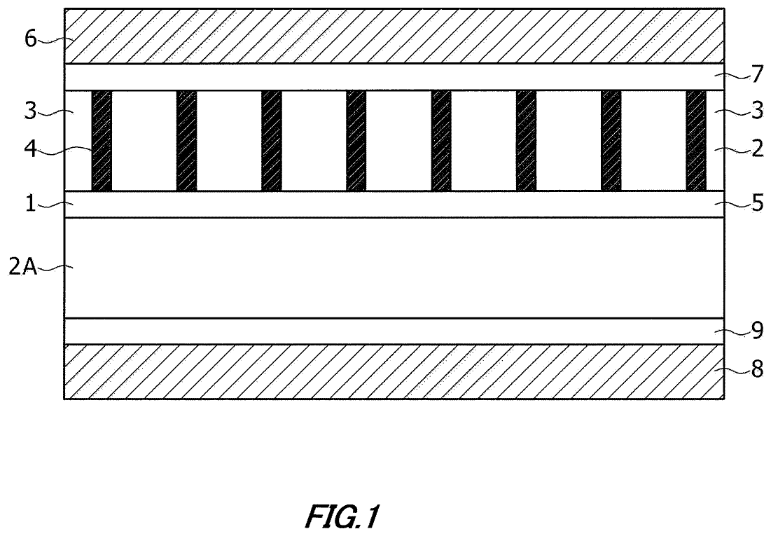

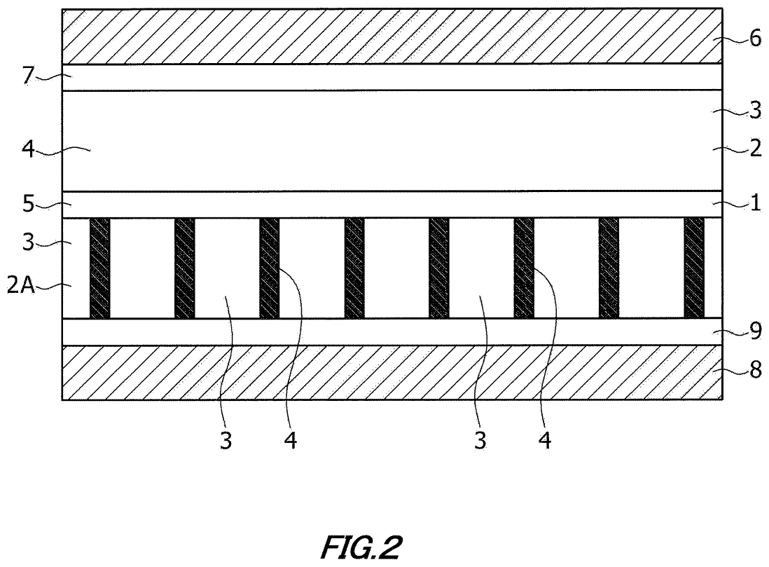

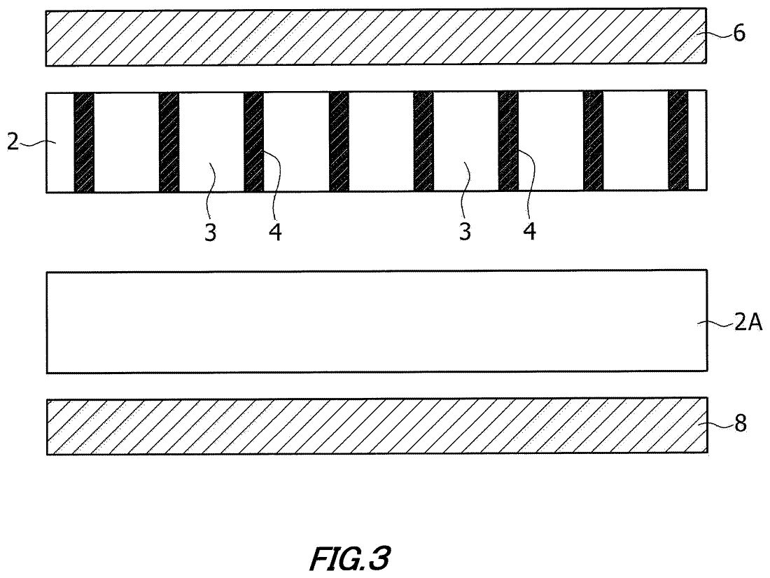

Hereinbelow, a preferred embodiment of the present invention will be described with reference to the drawings. As shown in FIGS. 1 to 3, a light transmission direction control sheet 1 in this embodiment is a control sheet with a visible angle of 90°, which includes first and second louver layers 2 and 2A opposing each other, an interlayer adhesive layer 5 that bonds the first and second louver layers 2 and 2A, a light-transmissive obverse surface film layer 6 opposite to the obverse surface of the first louver layer 2, an obverse surface-side adhesive layer 7 that bonds the first louver layer 2 and the obverse surface film layer 6, a light-transmissive reverse surface film layer 8 opposite to the reverse surface of the second louver layer 2A, and a reverse-surface side adhesive layer 9 that bonds the second louver layer 2A and the reverse surface film layer 8. The sheet contributes to the achievement of Goal 9 of the SDGs (the United Nations' international goals for sustainable development, and a sustainable development goal consisting of 17 global goals and 169 targets (achievement criteria) ) adopted at the United Nations Summit.

As shown in FIGS. 1 to 3, the light transmission direction control sheet 1 is shaped into a rectangular form, such as a plane rectangle or a square in a plan view, but may has a cutout at least partly on the periphery, may has a curved portion at least partly on the periphery, or may be beveled at least one of the four corners. This light transmission direction control sheet 1 may and should have an overall light transmittance (total light transmittance) of 46% or more, preferably 46% or more and 100 % or less, more preferably 47% or more and 90 % or less, and even more preferably 48% or more and 80 % or less. This is because visibility deteriorates when the overall light transmittance is lower than 46%.

The light transmittance herein is a value calculated by a formula:

Light transmittance=(B/A)×100 (unit: %), where in a device that measures the intensity of the test light emitted from a light source D65 that is specified in JIS Z 8720, by a light receiving sensor, A is the output value of the light receiving sensor when there is no object to be measured on the optical path of the test light and B is the output value when an object to be measured is set on the optical path of the test light and the transmitted light that has passed through the object to be measured is received by the light receiving sensor.

The first and second louver layers 2 and 2A are formed by alternatively and repeatedly arranging a plurality of light-transmitting strips 3 and light-shielding strips 4 in a horizontal row so that they have a plane rectangular square shape of the same size in a plan view with each other, and are stacked crosswise in the vertical direction (Z-direction). From the viewpoint of adjusting the directionality of light passing through the light transmission direction control sheet 1 in any direction and facilitating manufacturing, the thickness of the first and second louver layers 2 and 2A is specified to be 100 μm or more and 5000 μm or less, preferably 500 μm or more and 3500 μm or less, more preferably 600 μm or more i and 2000 μm or less, and even more preferably about 1200 μm.

Note that the up-down, obverse-reverse, left-right directions of the light transmission direction control sheet 1 are referred to the direction based on the drawings, and can be changed as required.

The thickness of the first and second louver layers 2 and 2A is made uniform, but the uniformness here includes a range of ±5 % of the design value in a thickness direction. The thickness of the first and second louver layers 2 and 2A can be measured from the cross-sectional photographs of each of the first and second louver layers 2 and 2A, and the average of values obtained by measuring at 10 or more points is preferably used.

The angle at which the first and second louver layers 2 and 2A intersect should be approximately perpendicular, taking into consideration the improvement of light transmittance and tolerances. Specifically, it is optimal that the angle is specified to be 85° or more and 95° or less, preferably 88° or more and 92° or less, and more preferably 90°.

From the viewpoint of reducing the number of parts, in the first and second louver layers 2 and 2A, each of the light-transmitting strips 3 is formed in a strip shape of transparent silicone rubber that has excellent heat resistance of 90° C. or higher, cold resistance, moisture resistance, environment-resistant characteristics, flexibility, colorability, transparency, etc., and contributes to preventing warping and deformation while each of the light-shielding strips 4 is formed in a strip shape of a transparent silicone rubber that has been colored to shield light, and these light-transmitting strips 3 and light-shielding strips 4 are formed at the same height, making the obverse side and reverse side symmetrical.

Examples of silicone rubber include a silicone rubber composition generally called millable rubber, which is made of a diorganopolysiloxane with molecular chain ends blocked by hydroxysilyl or vinylsilyl groups and an organic peroxide; and a so-called addition reaction type organosilicone rubber composition, which is made by compounding a diorganopolysiloxane having at least two vinyl groups bonded to silicon atoms in the molecule with an organohydrogenpolysiloxane having at least three hydrogen atoms bonded to silicon atoms (i.e., SiH bonds) in the molecule and a platinum catalyst. A specific example of the silicone rubber is KE-153U (the name of a product manufactured by Shin-Etsu Chemical Co., Ltd.) .

The silicone rubber should optimally have a density of 1.21 g/cm³ or more and 1.25 g/cm³ or less, preferably around 1.24 g/cm³ when measured at 23° C., in accordance with JIS K 6268. In view of preventing warping and deformation of the first and second louver layers 2 and 2A, the Shore A hardness should optimally be 73 or more and 83 or less, preferably 78 or more and 79 or less when measured with a rubber/plastic hardness tester (type A durometer) in accordance with JIS K 6253.

Additionally, in view of preventing warping and deformation, the tensile strength should optimally be 7.5 MPa or more and 13.5 MPa or less, preferably around 10.5 MPa when measured in accordance with JIS K 6251.

The silicone rubber should have an elongation at break of 270 % or more and 490 % or less, preferably 310 % or more and 380 % or less when measured in accordance with JIS K 6251. In addition, in order to prevent warping and deformation, the tear strength (crescent shape) measured in accordance with JIS K 6252 should be 8 kN/m or more and 28 KN/m or less, preferably 13 kN/m or more and 18 kN/m or less. These measurements can be performed using measuring instruments and testing machines from M&K Co., Ltd, ITS Japan Inc., etc.

The setting angles between the light transmitting strip 3 and the light-shielding strip 4 are each adjusted to 0 or more and 1° or less. Each light-transmitting strip 3 is formed of transparent silicone rubber so as to have a vertically long rectangular cross-section, and functions to transmit light. In view of controlling the directivity of light in a desired direction and facilitating manufacturing, the average width of this light-transmitting strip 3 is specified to be 50 μm or more and 200 μm or less, preferably 80 μm or more and 170 μm or less, more preferably 100 μm or more and 150 μm or less taking into account tolerances. In addition, in view of obtaining excellent transparency, the light transmittance when light is made incident only on the light transmitting strip 3 is 75 % or more, preferably 75 % or more and 100 % or less, and more preferably 85 % or more and 100 % or less.

Each light-shielding strip 4 is formed of silicone rubber that has been colored for light shielding, so as to be thinner and narrower than the light-transmitting strip 3 and have a vertically long cross-section and functions to block the light. The silicone rubber has a light shielding color thanks to addition of a coloring agent such as a pigment or dye to the type having the above physical properties for the light transmitting strip. Specific examples of coloring agents may include general organic or inorganic pigments such as carbonblack, iron oxide, titanium oxide, yellow iron oxide, disazoyellow, and phthalocyanine blue, but black carbonblack, which has excellent shielding properties, is optimal.

When a black pigment is not used as the coloring agent, it is preferable to use a white pigment in combination to ensure light-shielding properties. Only one kind of coloring agent may be used or two or more types may be used in combination. In addition, in view of controlling the directivity of light in a desired direction and facilitating manufacturing, the average width of each light-shielding strip 4 is specified to be 1 μm or more and 50 μm or less, preferably 5 μm or more and 30 μm or less, more preferably 8 μm or more and 20 μm or less, even more preferably around 10 μm, taking into account tolerances.

The interlayer adhesive layer 5 is formed of transparent silicone rubber having adhesive properties in consideration of its compatibility with silicone rubber, and bonds the opposing surfaces of the first and second louver layers 2 and 2A to allow light pass through. The transparent silicone rubber may be a silicone-based adhesive, or an adhesive silicone rubber sheet, which has excellent heat resistance of 90° C. or more, cold resistance, moisture resistance, environment-resistant characteristic, flexibility, transparency, and other properties, and contribute to preventing warping and deformation. Specific examples of silicone-based adhesives include KE-1825 (the name of a product manufactured by Shin-Etsu Chemical Co., Ltd.) and KE-1056 (the name of a product manufactured by Shin-Etsu Chemical Co., Ltd.) which are, for example, thermosetting adhesives.

It is optimal that the thickness of the interlayer adhesive layer 5 is 10 μm or more and 32 μm or less, preferably 15 μm or more and 25 μm or less, and more preferably about 20 μm, in view of thinning the light transmission direction control sheet 1.

It is optimal that the Shore A hardness of the interlayer adhesive layer 5 is 10 or more and 60 or less, preferably 10 or more and 30 or less or 30 or more and 60 or less, more preferably 10 or more and 30 or less or 50 or more and 60 or less when measured with a type A durometer in accordance with JIS K 6253.

This is because the hardness of the interlayer adhesive layer 5 being 10 or more and 60 or less can prevent warping and deformation of the first and second louver layers 2 and 2A. The light transmittance when light is made incident only on the interlayer adhesive layer 5 is preferably 65 % or more, preferably 65 % or more and 100 % or less, more preferably 80 % or more and 100 % or less, in view of obtaining excellent transparency.

The obverse surface film layer 6 is made of a polycarbonate resin film or the like that has excellent heat resistance of 90° C. or more, weather resistance, impact resistance, dimensional accuracy and transparency, and is resistant to warping and deformation, and transmits light. The thickness of the transparent obverse surface film layer 6 is specified to be 0.1 mm or more and 0.3 mm or less, preferably 0.189 mm or more and 0.2 mm or less, more preferably 0.195 mm or more and 0.2 mm or less, and even more preferably around 0.2 mm, in view of reducing the installation space and ensuring rigidity to prevent warping.

In view of obtaining excellent transparency, it is desirable that the light transmittance when light is made incident only on the obverse surface film layer 6 is 75 % or more, preferably 75 % or more and 100 % or less, and more preferably 85 % or more and 100 % or less. The polycarbonate resin film used for the obverse surface film layer 6 preferably has a flexural modulus of 91 MPa or more and 2300 MPa or less when measured in accordance with the measurement test method of ISO 178.

Similarly to the interlayer adhesive layer 5, the obverse surface-side adhesive layer 7 is formed of transparent silicone rubber having adhesive properties in consideration of compatibility with silicone rubber, and bonds the obverse surface of the first louver layer 2 and the obverse surface film layer 6 to allow light to pass through. The transparent silicone rubber may be a silicone-based adhesive, or an adhesive silicone rubber sheet, which has excellent heat resistance of 90° C. or more, cold resistance, moisture resistance, environment-resistant characteristics, flexibility, transparency, and other properties, and contribute to preventing warping and deformation. Specific examples of silicone-based adhesives include KE-1825 (the name of a product manufactured by Shin-Etsu Chemical Co., Ltd.) and KE-1056 (the name of a product manufactured by Shin-Etsu Chemical Co., Ltd.) which are, for example, thermosetting adhesives.

It is desirable that the thickness of the obverse surface-side adhesive layer 7 is 10 μm or more and 32 μm or less, preferably 15 μm or more and 25 μm or less, and more preferably around 20 μm, in view of thinning the light transmission direction control sheet 1. It is desirable that the Shore A hardness of the obverse surface-side adhesive layer 7 is preferably 10 or more and 60 or less, more preferably 10 or more and 30 or less or 50 or more and 60 or less when measured with a type A durometer in accordance with JIS K 6253.This is because the hardness of the obverse surface-side adhesive layer 7 being 10 or more and 60 or less can prevent warping and deformation of the light transmission direction control sheet 1. The light transmittance when light is made incident only on the obverse surface-side adhesive layer 7 is preferably 65 % or more, more preferably 65 % or more and 100 % or less, and more preferably 80 % or more and 100 % or less, in view of obtaining excellent transparency.

The reverse surface film layer 8 is made of a polycarbonate resin film or the like that has excellent heat resistance of 90° C. or more, weather resistance, impact resistance, dimensional accuracy, and transparency, is resistant to warping or deformation, and functions to transmit light. The thickness of this transparent reverse surface film layer 8 is specified to be 0.1 mm or more and 0.3 mm or less, preferably 0.189 mm or more and 0.2 mm or less, more preferably 0.195 mm or more and 0.2 mm or less, and even more preferably around 0.2 mm, in view of reducing the installation space and ensure rigidity to prevent warping.

In view of obtaining excellent transparency, it is desirable that the light transmittance when light is made incident only on the reverse surface film layer 8 is 75 % or more, preferably 75 % or more and 100 % or less, and more preferably 85 % or more and 100 % or less. The polycarbonate resin film used for the reverse surface film layer 8 preferably has a flexural modulus of 91 MPa or more and 2300 MPa or less when measured in accordance with the measurement test method of ISO 178.

Similarly to the interlayer adhesive layer 5, the reverse-surface side adhesive layer 9, is formed of transparent silicone rubber having adhesive properties in consideration of compatibility with silicone rubber, and functions to bond the reverse side of the second louver layer 2A to the reverse surface film layer 8 and allow light to pass through. The transparent silicone rubber may be a silicone-based adhesive or an adhesive silicone rubber sheet that has excellent heat resistance of 90° C. or more, cold resistance, moisture resistance, environment-resistant characteristics, flexibility, transparency, and other properties, and contribute to preventing warping and deformation. Specific examples of silicone-based adhesives include KE-1825 (the name of a product manufactured by Shin-Etsu Chemical Co., Ltd.) and KE-1056 (the name of a product manufactured by Shin-Etsu Chemical Co., Ltd.) .

It is optimal that the thickness of the reverse-surface side adhesive layer 9 is optimally 10 μm or more and 32 μm or less, preferably 15 μm or more and 25 μm or less, more preferably around 20 μm, in view of thinning the light transmission direction control sheet 1. It is optimal that the Shore A hardness of the reverse-surface side adhesive layer 9 is optimally 10 or more and 60 or less, preferably 10 or more and 30 or less or 50 or more and 60 or less when measured with a type A durometer in accordance with JIS K 6253. This is because the hardness of the reverse-surface side adhesive layer 9 being 10 or more and 60 or less can prevent warping and deformation of the light transmission direction control sheet 1. The light transmittance when light is made incident only on the reverse-surface side adhesive layer 9 is 65 % or more, preferably 75 % or more and 100 % or less, more preferably 80 % or more and 100 % or less, in view of ensuring excellent transparency.

When manufacturing the light transmission direction control sheet 1 in the above configuration, a plurality of transparent silicone rubber sheets for the transparent light transmitting strip and a plurality of silicone rubber sheets for the black-colored light-shielding strip are prepared, first. Then, these silicone rubber sheets for the light transmitting strip and these silicone rubber sheets for the light-shielding strip are stacked alternately to form a laminate. The silicone rubber sheet for the light transmitting strip and the silicone rubber sheet for the light-shielding strip can be manufactured by extrusion molding, calendar molding, and press molding. The silicone rubber sheet for the light transmitting strip and the silicone rubber sheet for the light-shielding strip may be bonded by heat pressing, but it is best to alternately laminate and bond them with a silicone-based transparent adhesive, which is expected to provide reliable adhesion.

Subsequently, the laminate is heated, vulcanized, and pressurized to form a block body, which is cut to form the first and second louver layers 2 and 2A in sheet form, and a transparent adhesive silicone rubber that will become the interlayer adhesive layer 5 is applied to the opposing surfaces of the first and second louver layers 2 and 2A. A transparent adhesive silicone rubber that will become the obverse surface-side adhesive layer 7 is applied to the exposed surface of the first louver layer 2 while a transparent adhesive silicone rubber that will become the reverse-surface side adhesive layer 9 is applied to the exposed reverse side of the second louver layer 2A. Since the first and second louver layers 2 and 2A are made of silicone rubber that does not warp easily, they can be directly bonded together to create a thin structure. Also, the use of silicone rubber is expected to thin the interlayer adhesive layer 5.

Next, the opposing surfaces of the first and second louver layers 2 and 2A are pressed together to bond them together. At this time, the two louvers are laminated and bonded so that the arrangement directions of the light-shielding strips 4 of the first and second louver layers 2 and 2A are placed orthogonal to each other at an angle of 90°. Also, before or after bonding the opposing surfaces together, the obverse surface film layer 6 and the reverse surface film layer 8 are laminated and bonded to the corresponding adhesive silicone rubbers that will form the obverse surface-side adhesive layer 7 and the reverse-surface side adhesive layer 9. Once all the lamination and bonding work has been thus completed, all the layers of uncured adhesive silicone rubber are thermally cured and unnecessary sections of the obverse surface film layer 6 and the reverse surface film layer 8 are removed, so that the light transmission direction control sheet 1 can be manufactured.

In the manufactured light transmission direction control sheet 1, the difference in refractive index of the interlayer adhesive layer 5 from the first and second louver layer 2, 2A should be 0.02 or less, preferably 0 or more and 0.02 or less, more preferably 0. 001 or more and 0.02 or less, and even more preferably 0.01 or more and 0.02 or less. This is because if the difference in refractive index is 0.02 or less, it is expected that interface reflection can be prevented. These differences in refractive index can be measured with a refractometer in accordance with JIS K 7142 after the test pieces are manufactured.

On the other hand, in order to prevent interface reflection, the refractive index of the light transmitting strips 3 of the first and second louver layers 2 and 2A in the manufactured light transmission direction control sheet 1 should be 1.41 or more and 1.43 or less, preferably around 1.42. Also, the refractive indices of the interlayer adhesive layer 5, the obverse surface-side adhesive layer 7 and the reverse-surface side adhesive layer 9 should be 1.40 or more and 1.42 or less, and preferably around 1.41, to prevent interface reflection. The refractive indices of the obverse surface film layer 6 and the reverse surface film layer 8 should be 1.57 or more and 1.59 or less, for example, around 1.58 when the obverse surface film layer 6 and the reverse surface film layer 8 are made of polycarbonate resin film. These refractive indices can be measured with a refractometer in accordance with JIS K 7142, as mentioned above.

According to the above configuration, the first and second louver layers 2 and 2A are formed of silicone rubber that is flexible and free from warping, so that the number of pairs of internal film layers 35 and 35A and adhesive layers 33 having different refractive indices can be reduced. Therefore, the number of interfaces can be reduced, so that it is possible to effectively eliminate the risk of the transmittance being lowered due to interface reflection. Furthermore, by reducing the number of parts, the light transmission direction control sheet 1 can be made thinner by at least 0.2 mm or more, thus effectively eliminating the risk of problems when it is assembled into equipment. Furthermore, when the average width of the light transmitting strip 3 is 100 μm or more and 150 μm or less, laminating and cutting works can be facilitated.

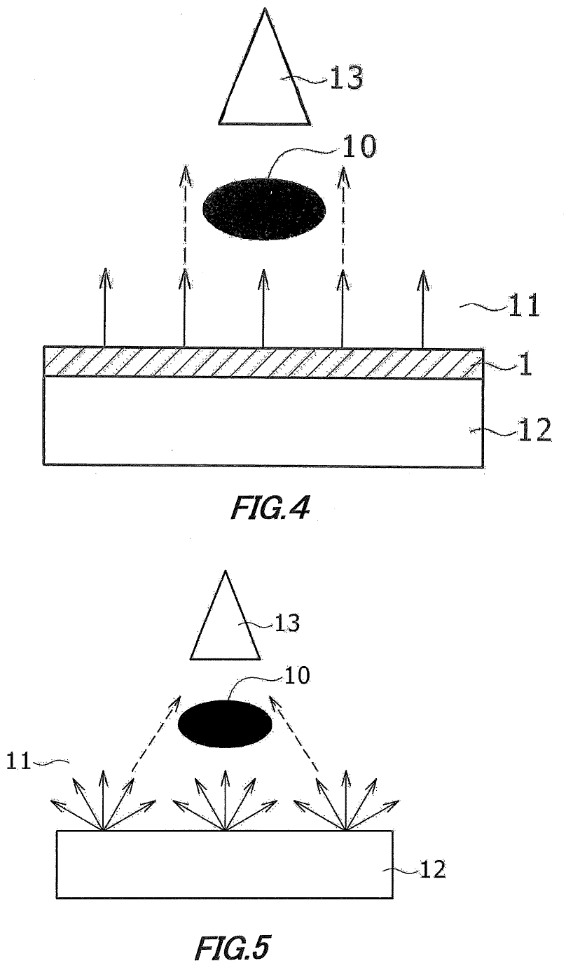

Next, FIG. 4 shows a second embodiment of the present invention, in which the manufactured light transmission direction control sheet 1 is attached to a detection device 11 that radiates light onto an opaque workpiece 10 which is an object under irradiation, so as to control the optical path of the light.

The workpiece 10 is, for example, a machine part transported by a conveyor in the manufacturing industry, and is formed in a circular, elliptical, spherical, or other shape. The detection device 11 includes, for example, a light source 12 for irradiating light onto the workpiece 10, and a detection sensor 13 such as a visual sensor (camera) that picks up an image of the workpiece 10 irradiated with light from the light source 12 to detect its shape and dimensions. The light source 12 and the detection sensor 13 are installed around the conveyor horizontally with being opposed to each other. The light source 12 is, for example, a backlight that radiates diffused light, and a light transmission direction control sheet 1 is attached to the irradiating surface. The other configurations are the same as those in the above embodiment, so that explanations are omitted.

In this embodiment, the same advantages as in the above embodiment can be expected, and the edge of the workpiece 10 can be clarified so that the shape and dimensions of the workpiece 10 can be detected with high accuracy. To explain this advantages in detail, when the light transmission direction control sheet 1 is not attached to the light source 12 and the light is diffused light, the shadow of the edge of the workpiece 10 becomes unclear due to light diffraction and other reasons as shown in FIG. 5, so that there is a risk that the shape and dimensions of the workpiece 10 cannot be detected. In view of this, when the light transmission direction control sheet 1 is attached to the light source 12, the light path of the light can be controlled to radiate the light horizontally, so that the shadow of the edge of the workpiece 10 can be clarified. Therefore, it is expected that the edge of the workpiece 10 will be clarified, thus making it possible to prevent erroneous recognition of the workpiece 10 and detect the shape and dimensions of the workpiece 10 with high accuracy.

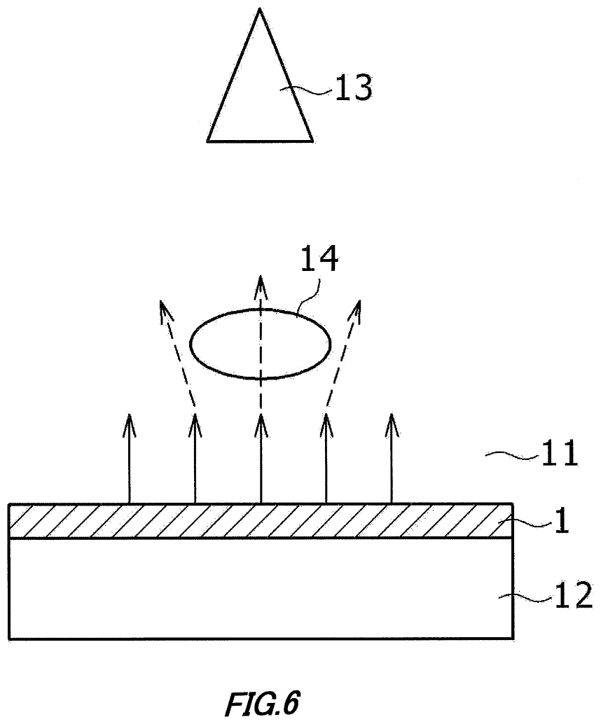

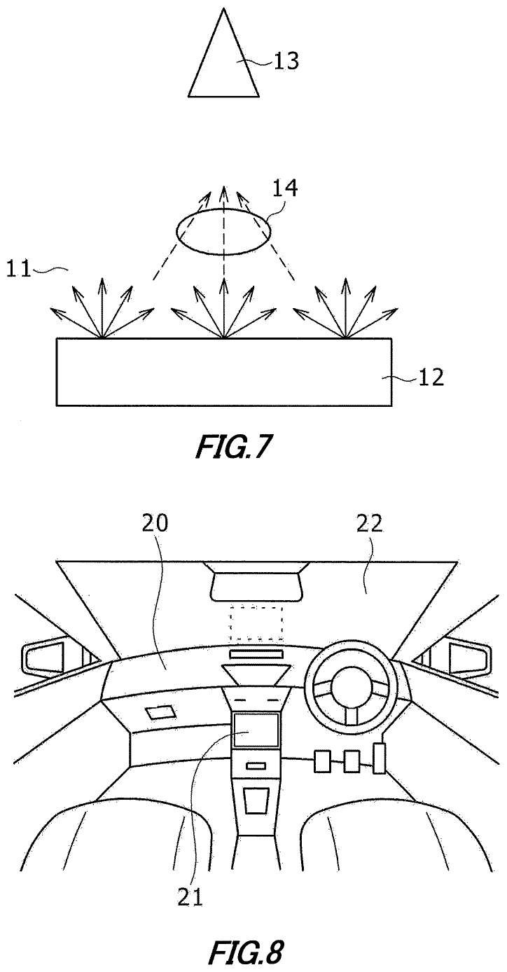

Next, FIG. 6 shows a third embodiment of the present invention, in which the manufactured light transmission direction control sheet 1 is attached to a detection device 11 that radiates light onto a light-transmissive bottle or liquid 14 which is an object under irradiation, so as to control the optical path of the light.

The liquid 14 is, for example, a kind of transparent drinking water, which is poured into the top opening of a light-transmitting bottle from above. The detection device 11 includes, for example, a light source 12 that radiates light onto the liquid 14 to be filled, and a detection sensor 13 such as a visual sensor (camera) that captures the image of the liquid 14 irradiated with light from the light source 12 to detect whether it is filled or not, and is installed with the light source 12 and the detection sensor 13 facing each other horizontally, around the conveyor for transporting bottles. The light source 12 is, for example, a backlight radiating light of diffused light, and the light transmission direction control sheet 1 is attached to the radiating surface. The other configurations are the same as those of the above embodiment, so explanation will be omitted.

Also in this embodiment, the same advantages as in the above embodiment can be expected, and the side edges of the liquid 14 can be clearly recognized so that the presence or absence of the liquid 14 can be detected with high accuracy. To explain the advantages in detail, when the light transmission direction control sheet 1 is not attached to the light source 12 and the light is diffused light, the light passes through the whole part of liquid 14, so that there is a risk that the presence or absence of the liquid 14 cannot be detected. In view of this, attachment of the light transmission direction control sheet 1 to the light source 12 can control the light path of the light to radiate the light horizontally, so that the light can be made incident or reflected on the liquid 14 at an angle of approximately 90° (89 ° or 90°). Therefore, the side edges of the liquid 14 does not allow the light to pass through, hence can be recognized as black, so that it is possible to prevent erroneous recognition of the liquid 14 and detect the presence or absence of the liquid 14 with high accuracy.

Next, FIG. 8 shows a fourth embodiment of the present invention, in which the light transmission direction control sheet 1 is fitted to the image display device 21 below the dashboard 20 of an automobile to control the optical path of light. The other configurations are the same as those of the above embodiment, so the description will be omitted.

Also in this embodiment, the same advantages as in the above embodiment can be expected, and the risk of hinderance to driving the automobile can be eliminated. To explain these advantages in detail, when the image display device 21 is mounted below the dashboard 20 of an automobile, the image on the image display device 21 may be reflected on the windshield 22 or door glass of the automobile, which may interfere with driving the automobile (see dotted line in FIG. 8). In view of this, attachment of the light transmission direction control sheet 1 of this embodiment to a light source such as the backlight of the image display device 21, can control the emission of light in vertical and horizontal directions, hence eliminate the risk of the image being reflected on the windshield 22 or door glass of the vehicle, which could interfere with the driving of the automobile.

In addition, at least one of the obverse surface film layer 6 and the reverse surface film layer 8 in the above embodiment may be treated with an anti-glare (AG) coating to prevent light from being reflected and dazzling, or may be treated with a hard coat, etc. Also, at least one of the obverse surface film layer 6 and the reverse surface film layer 8 may be laminated with a protective acrylic plate. It is also possible that at least one of the obverse surface film layer 6 and the reverse surface film layer 8 is made of a polyethylene terephthalate resin film or the like.

Alternatively, the manufacturing procedure of the light transmission direction control sheet 1 may be changed. That is, after forming the first and second louver layers 2 and 2A, adhesive silicone rubber that will become the interlayer adhesive layer 5 is applied to the opposing surfaces of the first and second louver layers 2 and 2A, and the opposing surfaces of the first and second louver layers 2 and 2A are bonded together and thermally cured. Subsequently, adhesive silicone rubber that will become the obverse surface-side adhesive layer 7 is applied to the exposed surface of the first louver layer 2 while adhesive silicone rubber that will become the reverse-surface side adhesive layer 9 is applied to the exposed reverse surface of the second louver layer 2A. Then, the obverse surface film layer 6 and the reverse surface film layer 8 are stacked and bonded to the corresponding adhesive silicone rubber and thermally cured. Finally, unnecessary portions of the obverse surface film layer 6 and the reverse surface film layer 8 are removed.

### EXAMPLE

Now, an example of the light transmission direction control sheet and its manufacturing method according to the present invention will be described together with a comparative example.

### Example

To manufacture a light transmission direction control sheet with a visible angle of 90°shown in FIGS. 1 to 3, first, a plurality of transparent silicone rubber sheets for the light transmitting strip and a plurality of black-colored silicone rubber sheets for the light-shielding strip were prepared. The plurality of silicone rubber sheets for the light transmitting strip and the silicone rubber sheets for the light-shielding strip were alternately stacked and heat-pressed to form a laminate. For each silicone rubber sheet for the light transmitting strip, KE1571U (the name of a product manufactured by Shin-Etsu Chemical Co., Ltd.) with a thickness of 125 μm was used. For the silicone rubber sheet for the light-shielding strip, KE153U (the name of a product manufactured by Shin-Etsu Chemical Co., Ltd.) with a thickness of 10 μm was used, which is a blend of 100 parts by mass of silicone rubber and 15 parts by mass of carbon black.

In configuring the laminate, the Shore A hardness, tensile strength, elongation at break, and tear strength (crescent shape) of the silicone rubber sheet for the light transmitting strip used in the laminate were measured. As a result of the measurements, the Shore A hardness of the test piece of the silicone rubber sheet measured in accordance with JIS K 6253-3 was 78, the tensile strength of the silicone rubber sheet measured in accordance with JIS K 6251 was 10.5 MPa, the elongation at break of the silicone rubber sheet measured in accordance with JIS K 6251 was 380 %, and the tear strength of the silicone rubber sheet measured in accordance with JIS K 6252 was 18 KN/m. The Shore A hardness of the test piece was measured using an Asker Rubber Hardness Tester Type A (the name of a product manufactured by KOBUNSHI KEIKI CO., LTD.) .

Then, the laminate was heated, vulcanized, and pressurized to form a block. This block was cut to form sheets of the first and second louver layers of 1.2 mm thick. The block was cut along a cutting plane perpendicular to the surface of the sheet. After the first and second louver layers have been formed in this way, an uncured thermosetting adhesive that forms an interlayer adhesive layer was applied to the opposing surfaces of the first and second louver layers while an uncured thermosetting adhesive that forms an obverse surface-side adhesive layer was applied to the exposed surface of the first louver layer and an uncured thermosetting adhesive that forms a reverse-surface side adhesive layer was applied to the rear surface of the second louver layer. KE1825 (the name of a product manufactured by Shin-Etsu Chemical Co., Ltd.) was used for each of the thermosetting adhesives.

Subsequently, the opposing surfaces of the first and second louver layers were bonded together, the obverse surface film layer and the rear film layer were stacked and bonded to the thermosetting adhesive that form the obverse surface-side adhesive layer and rear-side adhesive layer, and all of the thermosetting adhesives were thermally cured to form interlayer adhesive layers, obverse surface-side adhesive layer and rear-side adhesive layer, each having a thickness of 0.02 mm. At this time, the first and second louver layers were stacked and bonded with the length direction of light-shielding strips of one layer positioned perpendicular to the other, or at an angle of 90°. For the obverse surface film layer and the reverse surface film layer, each of commercially available polycarbonate resin films of 0.2 mm thick were used. The measurements of the Shore A hardness of the interlayer adhesive layer, obverse surface-side adhesive layer, and reverse-surface side adhesive layer formed was performed using a test pieces with a type A durometer in accordance with JIS K 6253-3, and were 30. The specific measuring device used was an Asker Rubber Hardness Tester Type A (the name of a product manufactured by KOBUNSHI KEIKI CO., LTD.) After thermal curing, unnecessary parts of the obverse surface film layer and reverse surface film layer were removed to produce a thin light transmission direction control sheet with a visible angle of 90°. The light transmittance of the entire light transmission direction control sheet produced was measured, and the overall light transmittance was 48%, presenting a good result. The light transmittance herein is a value calculated by a formula:

Light transmittance=(B/A)×100 (unit: %), where in a device that measures the intensity of the test light emitted from a light source D65 that is specified in JIS Z 8720, by a light receiving sensor, A is the output value of the light receiving sensor when there is no light transmission direction control sheet to be measured on the optical path of the test light and B is the output value when a light transmission direction control sheet to be measured is set on the optical path of the test light and the transmitted light that has passed through the light transmission direction control sheet is received by the light receiving sensor.

The refractive indices of the light transmitting strips of the first and second louver layers in the manufactured light transmission direction control sheet were measured to be 1.42 for each. The refractive indices of the interlayer adhesive layer, obverse surface-side adhesive layer, and reverse-surface side adhesive layer were measured 1.41, whereas the refractive indices of the obverse surface film layer and reverse surface film layer were each measured 1.58. These refractive indices were measured with a refractometer in accordance with JIS K 7142. As a refractometer, a multi-wavelength Abbe refractometer DR-M2 (the name of a product manufactured by ATAGO CO., LTD.) with a measurement wavelength of 589 nm was used.

### COMPARATIVE EXAMPLE

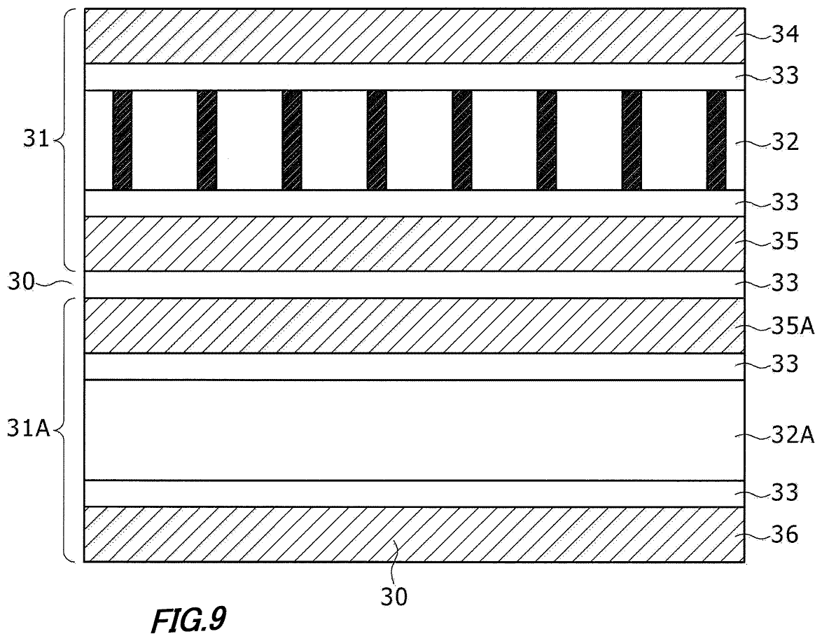

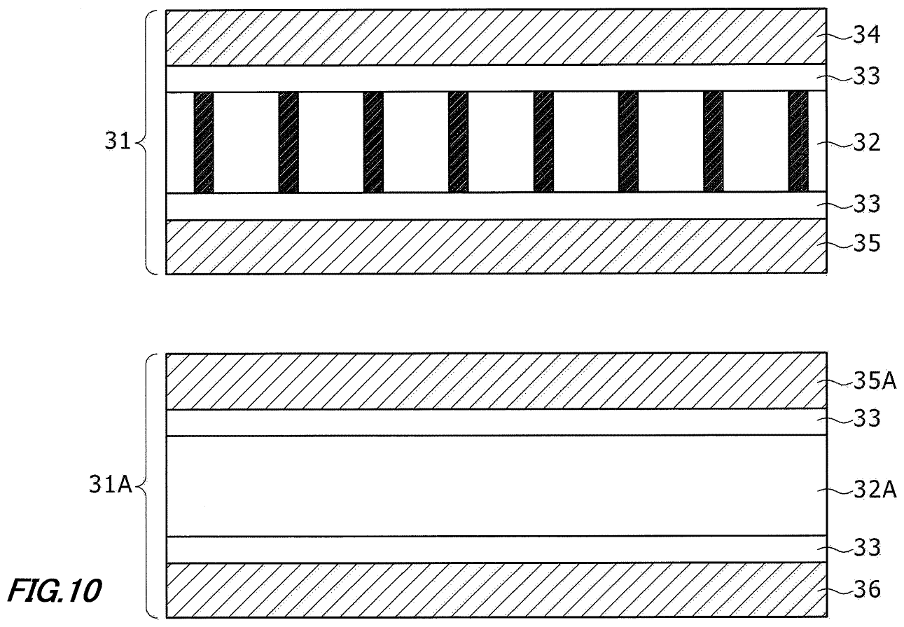

To manufacture the light transmission direction control sheet shown in FIGS. 9 and 10, the first louver layer of the first louver layer group was manufactured first. This first louver layer was formed the same as the first louver layer of the Example. After the first louver layer was formed, a thermosetting adhesive to be an adhesive layer of 0.02 mm thick was applied to both the obverse and reverse sides of this first louver layer. The obverse surface film layer and the first internal film layer were laminated and bonded to these thermosetting adhesives and thermally cured to manufacture the first louver layer group. Used as the thermosetting adhesive was KE1825 (the name of a product manufactured by Shin-Etsu Chemical Co., Ltd). The obverse surface film layer and the first internal film layer used a commercially available polycarbonate resin film of 0.2 mm thick.

Subsequently, the second louver layer group was manufactured in the same manner as the first louver layer group. Applied to the surface of the second inner film layer of the second louver layer group was a thermosetting adhesive to form an adhesive layer of 0.02 mm thick. Then, the first inner film layer of the first louver layer group was stacked and bonded perpendicularly to the second inner film layer and then thermally cured to complete a thick light transmission direction control sheet as shown in FIGS. 9 and 10. When the light transmittance of the thus manufactured entire light transmission direction control sheet was measured using the same measuring method as in the Example, the overall light transmittance ended up only 42%, presenting a need of improvement.

### INDUSTRIAL APPLICABILITY

The light transmission direction control sheet and its manufacturing method according to the present invention may be used in the manufacturing fields of detection devices, image display devices, medical equipment such as an infusion devices, liquid crystal displays, CIDs, water meters, etc.

### DESCRIPTION OF REFERENCE NUMERALS

1 light transmission direction control sheet
2 first louver layer
2A second louver layer
3 light-transmitting strip
4 light-shielding strip
5 interlayer adhesive layer
6 obverse surface film layer
7 obverse surface-side adhesive layer
8 reverse surface film layer
9 reverse-surface side adhesive layer
10 workpiece (irradiated object)
11 detection device
12 light source
13 detection sensor
14 liquid (irradiated object)
20 dashboard
21 image display device
30 light transmission direction control sheet
31 first louver layer group
31A second louver layer group
33 adhesive layer

1. A light transmission direction control sheet comprising:
first and second louver layers opposing to each other;
an interlayer adhesive layer bonding the first and second louver layers;
an obverse surface film layer opposing to an obverse surface of the first louver layer, the obverse surface film layer being light-transmissive;
an obverse surface-side adhesive layer bonding the first louver layer and the obverse surface film layer;
a reverse surface film layer opposing to a reverse surface of the second louver layer, the reverse surface film layer being light-transmissive; and
a reverse-surface side adhesive layer bonding the second louver layer and the reverse surface film layer,
wherein
the first and second louver layers are laminated crosswise,
the first and second louver layers are each formed by arranging a plurality of light-transmitting strips and a plurality of light-shielding strips, alternately, each light-transmitting strip is formed of a light transmissive silicone rubber, each light-shielding strip is formed of a colored silicone rubber, a Shore A hardness of the silicone rubbers is 73 or more and 83 or less when measured with a type A durometer in accordance with JIS K 6253, and
the interlayer adhesive layer, the obverse surface-side adhesive layer, and the reverse-surface side adhesive layer are each formed of adhesive silicone rubber, having a Shore A hardness of 10 or more and 60 or less when measured with a type A durometer in accordance with JIS K 6253, and at least a thickness of the interlayer adhesive layer is 10 μm or more and 32 μm or less.

2. The light transmission direction control sheet according to claim 1, which is attached to a light source of a detection device that radiates light onto an irradiated object to control an optical path of the light.

3. The light transmission direction control sheet of claim 1, which is fitted to an image display device of an automobile to control an optical path of light.

4. The light transmission direction control sheet according to claim 1, wherein a difference in refractive index of the interlayer adhesive layer from the first and second louver layers is 0.02 or lower when measured with a refractometer in accordance with JIS K 7142.

5. The light transmission direction control sheet according to claim 1, wherein the silicone rubbers of the first and second louver layers have a tensile strength of 7.5 MPa or more and 13.5 MPa or less when measured in accordance with JIS K 6251, an elongation at break of 270 % or more and 490 % or less when measured in accordance with JIS K 6251, and a tear strength of 8 kN/m or more and 28 kN/m or less when measured in accordance with JIS K 6252.

6. A method for manufacturing the light transmission direction control sheet according to claim 1, comprising the steps of:
stacking a plurality of silicone rubber sheets for light transmitting strips and a plurality of silicone rubber sheets for light-shielding strips alternately to form a laminate;
pressurizing the laminate and cutting the laminate to form first and second louver layers;
applying adhesive silicone rubber to each of opposing surfaces of the first and second louver layers, an exposed surface of the first louver layer, and an exposed reverse surface of the second louver layer;
laminating and bonding the first and second louver layers crosswise to each other;
laminating and bonding an obverse surface film layer to the obverse surface of the first louver layer; and
laminating and boding a reverse surface film layer to the reverse surface of the second louver layer.
